(19) United States
(12) Patent Application Publication
(10) Pub. No.: US 2020/0389547 A1
(43) Pub. Date: Dec. 10, 2020

(54) MIDDLE FRAME ASSEMBLY, METHOD FOR MANUFACTURING THE SAME, AND ELECTRONIC DEVICE

(71) Applicant: FIH (HONG KONG) LIMITED, Kowloon (HK)

(72) Inventors: YU-SHENG CHANG, New Taipei (TW); HSIU-FU LI, New Taipei (TW); WEN-BIN HUANG, New Taipei (TW); SHEN-CHANG YU, New Taipei (TW)

(21) Appl. No.: 16/536,426

(22) Filed: Aug. 9, 2019

(30) Foreign Application Priority Data
Jun. 4, 2019 (CN) 201910482422.X

(51) Int. Cl. H04M 1/02; H01Q 1/24

(52) U.S. Cl. CPC H04M 1/026; B29C 45/1671; H01Q 1/243

(57) ABSTRACT

A method for manufacturing a middle frame assembly for a mobile phone manufactures a middle frame by sheet metal machining processes, forms an antenna on the middle frame by injection-molding processes, and forms an outer frame as a coating on an edge of the middle frame by the other injection-molding processes. The disclosure further provides a middle frame assembly and an electronic device. The method is simple and low in processing cost.

### FIELD

The subject matter herein generally relates to electronic devices.

### BACKGROUND

A middle frame assembly of a mobile phone comprises a middle frame and an antenna formed on the middle frame. The middle frame is formed by CNC machining of aluminum or stainless steel or by die casting of Al—Mg alloy. However, the CNC machining process and the die casting process are complicated, and have high material cost and high processing cost.

### BRIEF DESCRIPTION OF THE DRAWINGS

Implementations of the present technology will now be described, by way of embodiment, with reference to the attached figures.

FIG. 1 is a schematic view of an embodiment of a middle frame assembly.

FIG. 2 is a flowchart of an embodiment of a method for manufacturing a middle frame assembly.

FIG. 3 is a schematic view of an embodiment of a middle frame and an antenna.

FIG. 4 is a schematic view of an embodiment of a middle frame with an antenna by injection-molding processes.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more debytions from a true cylinder. The term “comprising,” when utilized, means “including, but not necessarily limited to”; it specifically indicates open-ended inclusion or membership in the so-described combination, group, series, and the like.

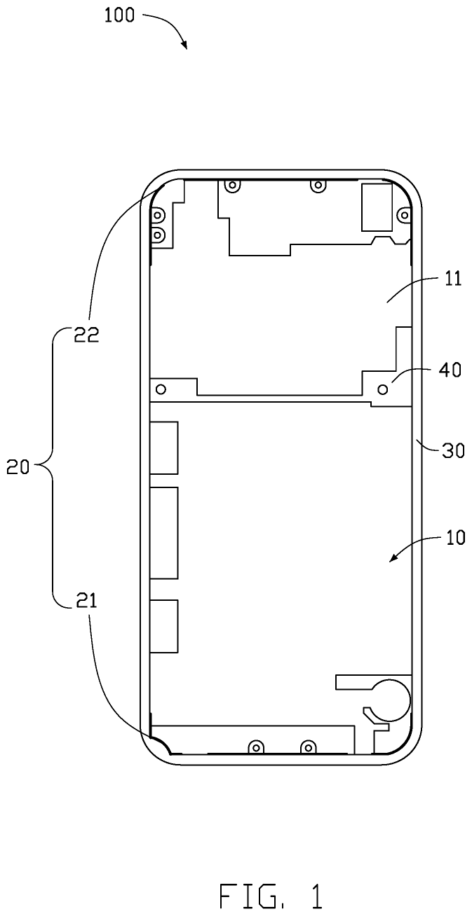

FIG. 1 illustrates a middle frame assembly 100 comprising a middle frame 10, an antenna 20, an outer frame 30, and a structural member 40.

The antenna 20 is fixed on the middle frame 10. The outer frame 30 encases a fringe of the middle frame 10. The structural member 40 is arranged in the middle frame 10.

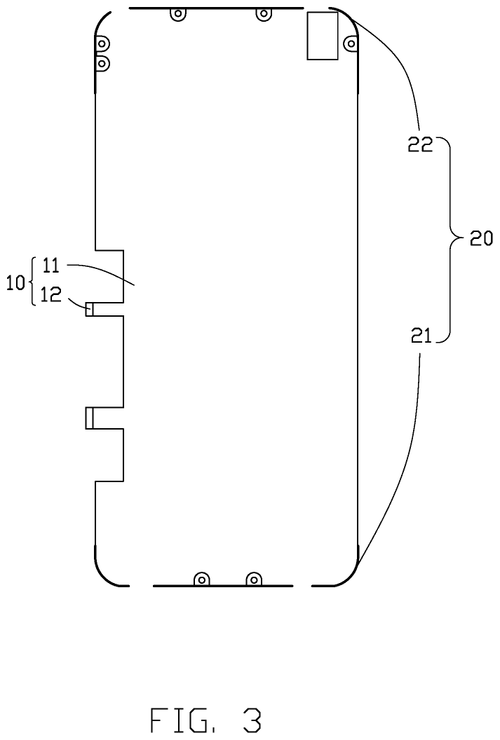

FIG. 3 illustrates the middle frame 10 comprising a substrate 11 and a folded plate 12. The folded plate 12 extends from an edge of the substrate 11 in a direction perpendicular to the substrate 11. The middle frame 10 is manufactured by sheet metal machining processes. The sheet metal machining processes, not only shortens the processing time, the processing is easier, but also the processing cost is reduced, and the processing yield is improved.

In an alternative embodiment, material of the middle frame 10 is stainless steel. Compared with other metal materials, stainless steel has low cost and high structural strength.

In an alternative embodiment, both of the substrate 11 and the folded plate 12 have a thickness of 0.3 mm to 0.4 mm.

In an alternative embodiment, during injection-molding processes of the antenna 20, the structural member 40 can be formed simultaneously in the middle frame 10. For example, the structural member 40 can be a plastic positioning member for later installation of other members.

The material of the antenna 20 is of metal. The antenna 20 is formed by the sheet metal machining processes. The antenna 20 comprises a main antenna 21 and an accessory antenna 22. The main antenna 21 and the accessory antenna 22 are arranged on opposite fringes of the middle frame 10. The accessory antenna 22 comprises a Global Position System (GPS) antenna and a Wi-Fi antenna.

The outer frame 30 is substantially rectangular. The outer frame 30 is cladding on the folded plate 12 of the middle frame 10. The material of the outer frame 30 is plastic.

In an alternative embodiment, the outer frame 30 can be other non-limited shapes according to actual needs, for example, the outer frame 30 can partially surround the outside of the folded plate 12.

The disclosure further provides an electronic device (not shown) comprising the middle frame 100 described above.

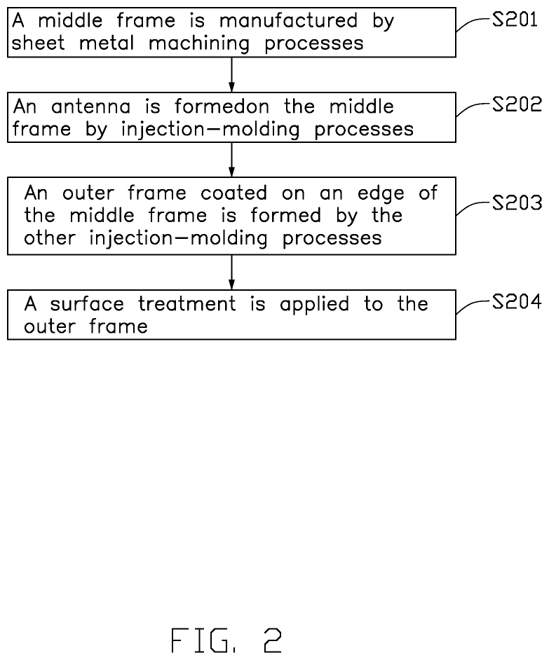

FIG. 2 illustrates a flowchart of a method for manufacturing the middle frame assembly. The method is provided by way of example, as there are a variety of ways to carry out the method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block S201.

At block S201, a middle frame is manufactured by sheet metal machining processes. In another word, a sheet metal is machined to produce the middle frame.

In detail, FIG. 3 illustrates the middle frame 10 comprising the substrate 11 and the folded plate 12 extending from the edge of the substrate 11 in a direction perpendicular to the substrate 11. The middle frame 10 is formed by the sheet metal machining processes. In another word, sheet metal is machined to produce the middle frame 10. Not only is the processing time shortened and the processing is easier, but also the processing cost is reduced and the processing yield is improved by employing the sheet metal machining processes.

In an alternative embodiment, the material of the middle frame 10 is stainless steel. Compared with other metal materials, stainless steel has low cost and high structural strength.

In an alternative embodiment, both of the substrate 11 and the folded plate 12 have a thickness of 0.3 mm-0.4 mm.

At block S202, an antenna is formed on the middle frame by injection-molding processes.

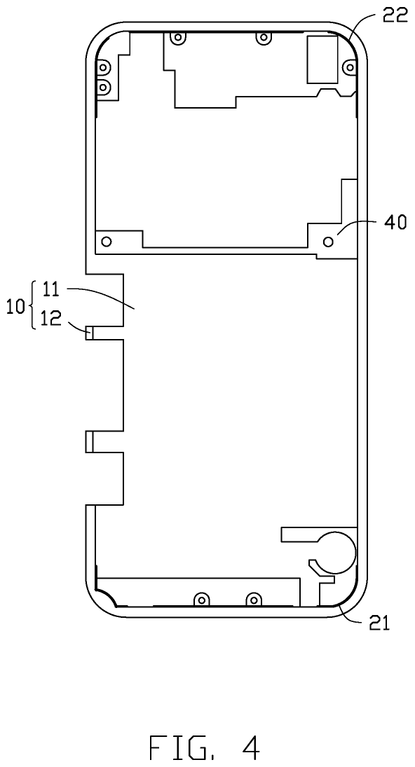

In detail, FIGS. 3 and 4 illustrate that the antenna 20 is made of metal. The antenna 20 comprises the main antenna 21 and the accessory antenna 22. Both of the main antenna 21 and the accessory antenna 22 are arranged on two corners of the same side of the middle frame 10. In an alternative embodiment, each of the main antenna 21 and the accessory antenna is arranged at a respective corner of the middle frame.

The main antenna 21 and the accessory antenna 22 are formed on corners of the middle frame 10 by the injection-molding processes.

In an alternative embodiment, during the injection-molding processes of the antenna 20, the structural member 40 can be formed simultaneously in the middle frame 10. For example, the structural member 40 can be a plastic positioning member for later installation of other members.

At block S203, an outer frame coated on an edge of the middle frame is formed by the other injection-molding processes.

In detail, FIG. 1 illustrates that the material of the outer frame 30 is plastic, and the outer frame 30 dads outside of the folded plate 12 of the middle frame 10 by the injection-molding processes. The outer frame 30 is substantially rectangular.

In an alternative embodiment, the outer frame 30 can be other shapes according to actual needs and is not limited, for example, the outer frame 30 can partially surround outside of the folded plate 12.

At block S204, a surface treatment is applied to the outer frame.

In detail, the surface of the outer frame 30 coated on the folded plate 12 is at least painted.

In an alternative embodiment, after forming the outer frame 30 on the edges of the middle frame 10, a laser etching treatment, a sand blasting treatment, a polishing treatment, and a coating treatment can be applied to the middle frame 10 or the outer frame 30 to improve the appearance of middle frame and to add functionality to the middle frame. For example, corrosion can be prevented from the outside by the coating treatment, and the life of the middle frame 10 is also extended.

It can be understood, the color of paint and the thickness of paint can be selected according to the actual needs.

The method for manufacturing the middle frame assembly 100 adopts the sheet metal machining processes to obtain the middle frame 10, and adopts two injection-molding processes to mold the antenna 20 and the outer frame 30 on the middle frame 10 in that order. The surface of the outer frame 30 is then coated. The method is simple, and low in processing cost.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A method for manufacturing a middle frame assembly comprising:
making a middle frame by sheet metal machining processes;
forming an antenna on the middle frame by a first injection-molding processes; and
forming an outer frame as a coating on an edge of the middle frame by a second injection-molding processes.

2. The method of claim 1, wherein the middle frame is made of stainless steel.

3. The method of claim 1, wherein the middle frame comprises a substrate and a folded plate extending from an edge of the substrate in a direction perpendicular to the substrate.

4. The method of claim 3, wherein the outer frame dads outside of the folded plate by the second injection-molding processes.

5. The method of claim 1, wherein a thickness of the middle frame is 0.3 mm to 0.4 mm.

6. The method of claim 1, wherein the antenna comprises a main antenna and an accessory antenna, each of the main antenna and the accessory antenna is arranged at a respective corner of the middle frame, the accessory antenna comprises a GPS antenna and a Wi-Fi antenna.

7. The method of claim 1, further comprising:
applying a surface treatment to the outer frame after forming the outer frame.

8. The method of claim 7, wherein the surface treatment comprises one or more of painting, laser etching, sand blasting, polishing, and coating.

9. A middle frame assembly comprising:
a middle frame;
at least one antenna formed on the middle frame by a first injection-molding processes; and
an outer frame coated on a fringe of the middle frame by a second injection-molding processes.

10. The middle frame assembly of claim 9, wherein the middle frame is made of stainless steel.

11. The middle frame assembly of claim 9, wherein the middle frame comprises a substrate and a folded plate extending from an edge of the substrate in a direction perpendicular to the substrate.

12. The middle frame assembly of claim 11, wherein the outer frame dads outside of the folded plate by the second injection-molding processes.

13. The middle frame assembly of claim 9, wherein a thickness of the middle frame is 0.3 mm to 0.4 mm.

14. The middle frame assembly of claim 9, wherein the antenna comprises a main antenna and an accessory antenna, each of the main antenna and the accessory antenna is arranged at a respective corner of the middle frame, the accessory antenna comprises a GPS antenna and a Wi-Fi antenna.

15. The middle frame assembly of claim 9, wherein a surface of the outer frame is treated by a surface treatment process.

16. The middle frame assembly of claim 15, wherein the surface treatment comprises one or more of painting, laser etching, sand blasting, polishing, and coating.

17. An electronic device comprising:
a middle frame assembly comprising:
a middle frame;
at least one antenna formed on the middle frame by a first injection-molding processes; and
an outer frame coated on a fringe of the middle frame and formed by a second injection-molding processes.
